(19) United States
(12) Patent Application Publication
(10) Pub. No.: US 2017/0329346 A1
(43) Pub. Date: Nov. 16, 2017

(54) VEHICLE AUTONOMOUS PARKING SYSTEM

(71) Applicant: MAGNA ELECTRONICS INC., Auburn Hills, MI (US)

(72) Inventor: Ralph Latotzki, Hamburg (DE)

(21) Appl. No.: 15/586,605

(22) Filed: May 4, 2017

Related U.S. Application Data
(60) Provisional application No. 62/448,092, filed on Jan. 19, 2017.
(60) Provisional application No. 62/335,248, filed on May 12, 2016.

(51) Int. Cl. G05D 1/02; G01C 21/34

(52) U.S. Cl. CPC G05D 1/0246; G01C 21/3438; G05D 1/0212

(57) ABSTRACT

An autonomous parking system for a vehicle includes a plurality of sensors disposed at the vehicle and sensing exterior of the vehicle. A control is operable to control steering, moving and stopping of the vehicle responsive at least in part to processing by a processor of captured data. Responsive to a user input, the control autonomously drives the vehicle from a drop-off location to a parking space and parks the vehicle at the parking space, and responsive to another user input, the control autonomously drives the vehicle from the parking space to a pick-up location, wherein one of (i) the pick-up location is different than the drop-off location, (ii) the control is operable to move the vehicle after it is parked and before or without actuation of the other user input, and (iii) the control communicates with controls of other vehicles in determining the parking space for the equipped vehicle.

### CROSS REFERENCE TO RELATED APPLICATIONS

The present application claims the filing benefits of U.S. provisional applications, Ser. No. 62/448,092, filed Jan. 19, 2017, and Ser. No. 62/335,248, filed May 12, 2016, which are hereby incorporated herein by reference in their entireties.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides an autonomous vehicle parking system that is operable to autonomously drive and park and move a vehicle after the driver has left the vehicle. The parking system may utilize one or more cameras or other sensors to capture image data or other sensing data representative of the area surrounding the vehicle. The autonomous vehicle parking system provides autonomous parking of the vehicle in a variety of situations, and is operable to autonomously move the vehicle to other locations, depending on the particular parking situation, and may drive the vehicle from the parked location to a pick-up location, which may or may not be the same location where the driver dropped off the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a plan view of a parking situation where a vehicle may be autonomously parked in a narrow garage in accordance with the present invention;

FIG. 3 is a plan view of a parking situation where a vehicle may be autonomously parked in a parking lot or structure in accordance with the present invention;

FIG. 4 is a plan view of a parking situation where a vehicle may be autonomously parked along a street in a nearby area in accordance with the present invention;

FIG. 5 is a plan view of a parking situation where a vehicle may be autonomously parked at a remote location in accordance with the present invention;

FIG. 6 is a plan view of a parking situation where a vehicle may be autonomously parked and returned so that the vehicle is facing the opposite direction upon return in accordance with the present invention;

FIG. 7A is a plan view of a parking situation where a vehicle may be autonomously parked at a parking structure near an airport terminal in accordance with the present invention;

FIG. 7B is a photograph of a vehicle on a transport platform within a multiple story parking tower of the Autostadt Wolfsburg;

FIG. 8A is a plan view of a parking situation where a vehicle may be autonomously parked in rows of parked vehicles where the parked vehicles can autonomously rearrange in accordance with the present invention;

FIG. 8B is a plan view of a crowded parking garage level for unmanned, autonomous (valet) parking vehicle, showing unoccupied spaces in between the parked vehicles having a leaf vein structure so as to serve as maneuvering and driving spaces for vehicles entering or exiting the parking area, wherein more vehicles find parking spaces in the shown order, as when parked conventionally;

FIG. 9 is a plan view of a parking situation where a vehicle may be autonomously parked at a charging station in accordance with the present invention;

FIG. 10 is a plan view of a parking situation where a vehicle may be autonomously parked at a parking structure near a shopping center and returned at a different location in accordance with the present invention;

FIG. 11A is a plan view of a parking situation where a vehicle may be autonomously parked at a rental car parking lot and driven to a pick-up location in accordance with the present invention;

FIG. 11B shows a map displayed on a smart phone showing the walking path a customer of an autonomous rental vehicle is supposed to take to a fixed rental car pick up spot, where the customer is currently in a no driving zone such that the vehicle cannot pick him or her up directly;

FIG. 11C shows a map displayed on a smart phone (app) showing the walking path a customer of an autonomous rental vehicle is supposed to take to an individually chosen rental car pick up spot, where the customer is currently in a no driving zone, such that the walking path is optimized to minimize the distance to an area where the traffic allows the rental vehicle to stop safely for picking up the customer;

FIG. 12 is a plan view of a parking situation where a vehicle may be autonomously parked at a fueling station in accordance with the present invention;

FIG. 13 is a plan view of a parking situation where a vehicle may be autonomously driven through a car wash in accordance with the present invention;

FIG. 14 is a plan view of a parking situation where vehicle may be autonomously parked at a ferry in a determined order in accordance with the present invention;

FIG. 15 is a plan view of a parking situation where vehicles may be autonomously parked at a train in accordance with the present invention;

FIG. 16 is a plan view of two parking situations I and II where vehicles may be autonomously parked at a street and may adjust the spacing between the parked vehicles to make room for another vehicle in accordance with the present invention;

FIG. 17 is a plan view of a parking situation where a vehicle may be left by the driver (position 1) and will autonomously park when a parking space opens up nearby (position 2) in accordance with the present invention;

FIG. 18 is a plan view of a parking situation where a vehicle (2) may be left by the driver at a reserved space and autonomously moved when the space is required by another vehicle (1) in accordance with the present invention;

FIG. 19A is a plan view of a parking situation where a vehicle may be parked at a street and under or near a tree and autonomously moved when another space (2) opens up in accordance with the present invention;

FIG. 19B shows a vehicle which was parked in Paris at a street that has vandalism of vehicles parked thereat;

FIG. 20 is a plan view of a parking situation where vehicles may be parked at an entrance and may autonomously move to unblock the entrance in accordance with the present invention;

FIG. 21 is a plan view of a parking situation where a vehicle may be parked at a driveway and may autonomously move to make room for another vehicle in accordance with the present invention;

FIG. 22 is a parking area traffic sign regulating that a Parkschein (parking ticket) is required to be purchased upfront (the more time the more expensive), where German parking traffic law requires that the Parkschein (parking ticket) must include the present time and must be placed at a spot behind the windshield readable from outside in such areas;

FIG. 23 is a Parkschein (parking ticket) as commonly acquirable at cashier machines at parking areas Parkschein (parking ticket), showing the location of the cashier machine;

FIG. 24 is a display content of a display or display area of an automated, driver less parking vehicle in accordance with the present invention, with the display area placed at the lower left corner of the windshield facing outward and displaying an image of a Parkschein (parking ticket) in the color tone, size and ratio required by law and showing the time that the parking time ends, and shown with an optional QR code displayed for easing the control activities of meter maids, and showing the Vehicle Identification Number (VIN), with the current parking spot's street and number being displayed for assigning the parking payment;

FIG. 25 is a parking area traffic sign indicating that the parking area is on the left, the parking time allowed is limited to two hours and it is required to put up a Parkscheibe (parking disc); and

FIG. 26 is a display content of a display or display area of an automated, driver less parking vehicle in accordance with the present invention, with the display area at the lower left corner of the windshield facing outward and displaying an image of a blue Parkscheibe (parking disc) in the color tone, size and ratio required by law with the arrival time rounded up to the next half hour as required by law, such that the real arrival time may have been 17:42h.

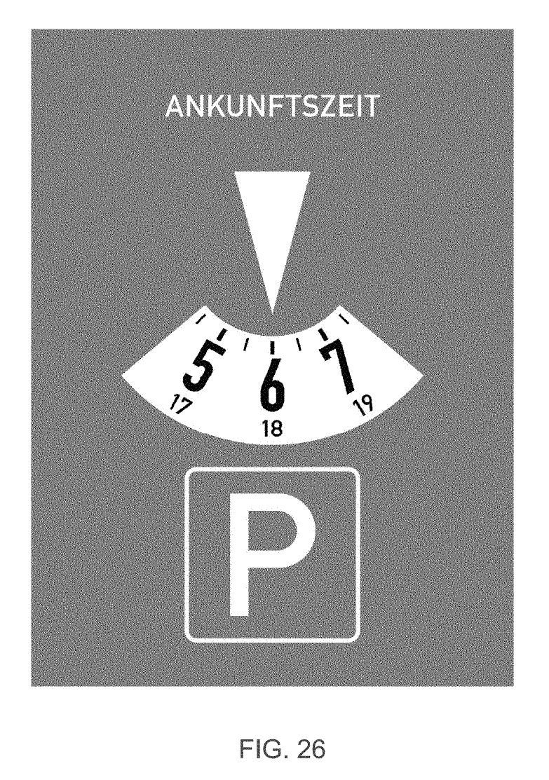

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

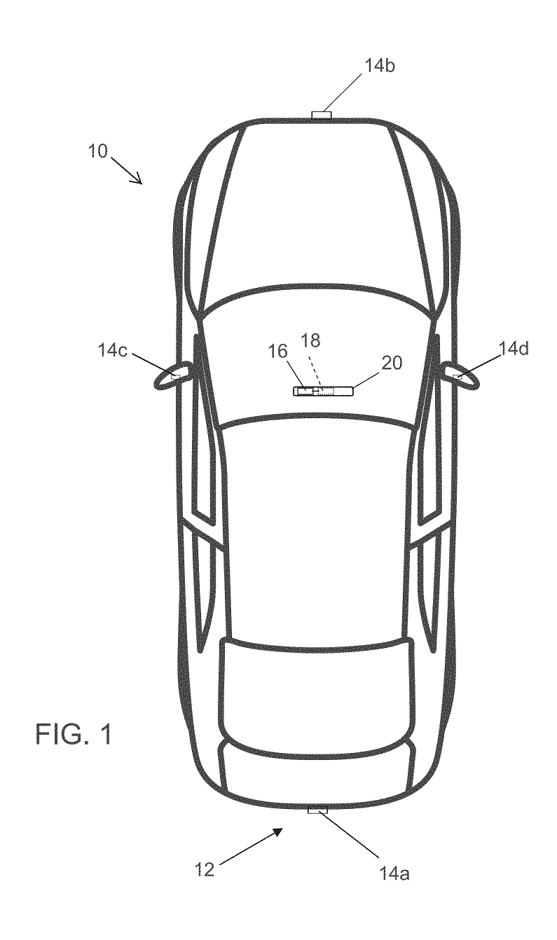

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forward facing camera 14b at the front (or at the windshield) of the vehicle, and a sideward/rearward facing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The user input can come from a cell phone of operator standing outside of the vehicle (remote operation). The vehicle or system can be operated by a parking garage valet (so that the garage at which the vehicle is parked can control the vehicle to allow for moving of the parked vehicles). The system can function drop off the driver and park at a designated or selected parking space, and can return to the drop off location to pick up the driver or can drive to another designated or selected or programmed location to pick up the driver.

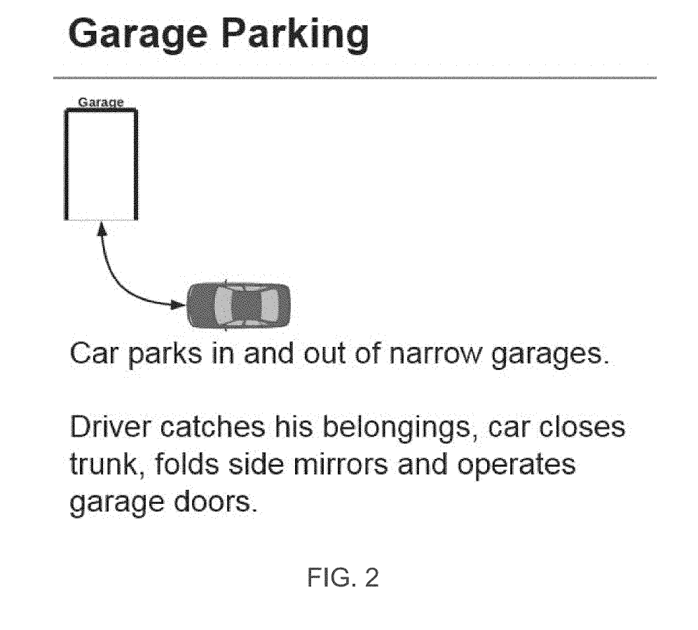

Nowadays the term ‘valet parking’ for vehicles has a wide scope: it may include ‘the vehicle is pulling autonomous (and often) supervised into a known private parking garage or parking lot after the driver has left his or her vehicle in front of the garage or parking lot or in front of the entrance of his or her house, letting the vehicle pass the driveway to the garage in an automated manner’, such as shown in FIG. 2. These systems are often limited to follow a known path. The vehicle supervision as well as transmitting of drive commands is typically been done by using cellular connections to smart phone apps. Typically, the vehicle owner stays in connection with the vehicle until it is finally parked. The vehicle may start and execute a return way upon request from the driver's smart phone.

Some systems are able to handle unforeseen obstacles which may lie in the driveway in a certain extend such as stopping or finding a way around it by its own. Typically, known vehicle inherent sensors and environment scene mapping and hazard determination algorithm are in use, supported by traffic rule data sets, vehicle dynamics controls and data sets. The sensors are typically at least one of ultrasound sensors, RADAR sensors, LIDAR sensors, mono- and/or stereo-camera with RGB or infrared (IR) sensors. The path's road properties and collision hazard determination is typically done by scene classification algorithms, and free space determination and again collision hazard detection algorithm is typically done via a two-dimensional (2D) free space map or 2D map with height stixels or by at least a low level of 3D reconstruction, especially in combination of sensors which deliver a depth signal (ultrasound-, RADAR-, LIDAR-sensors and stereo cameras) or by algorithms which use depth cues to estimate or determine the depth, such as a structure from motion algorithm on a mono camera. Often, several sensors may be fused for sensor-redundancy, -range, -opening angle and -resolution reasons. For example, data from RADAR sensors may be fused with data from mono cameras. Often the sensor's data additionally get crunched and preprocessed before or during fusion. The object classification and road property determinations are done by a classifier on a camera, while the hazard object distance determination can be led by the RADAR. Often artificial intelligence algorithm and training methods are used for optimizing the scene map and object determination and driving decision making.

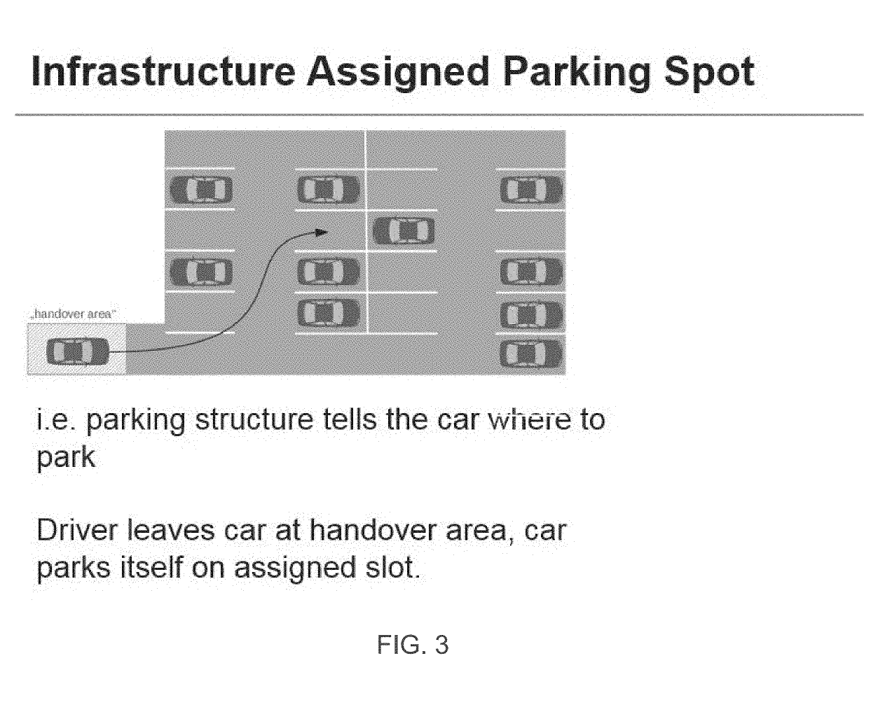

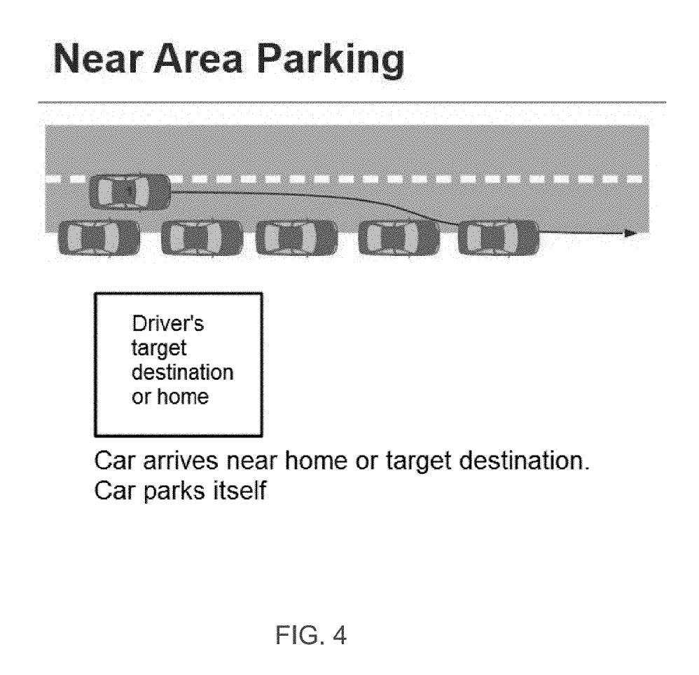

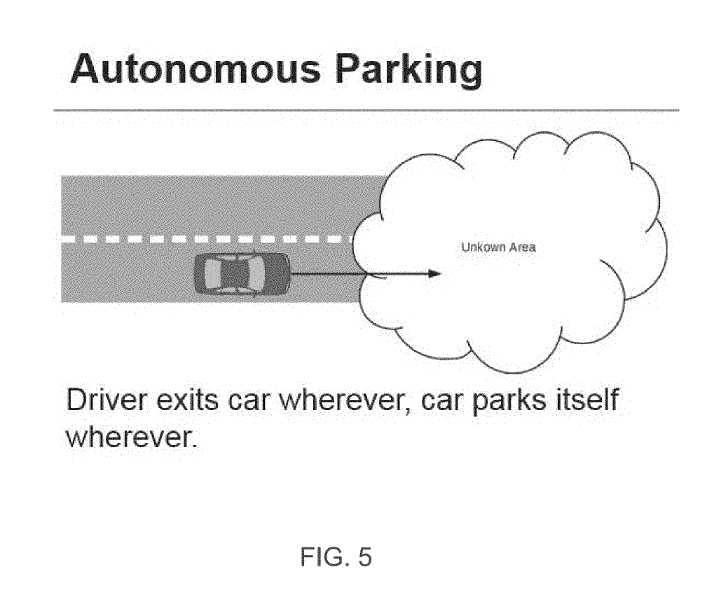

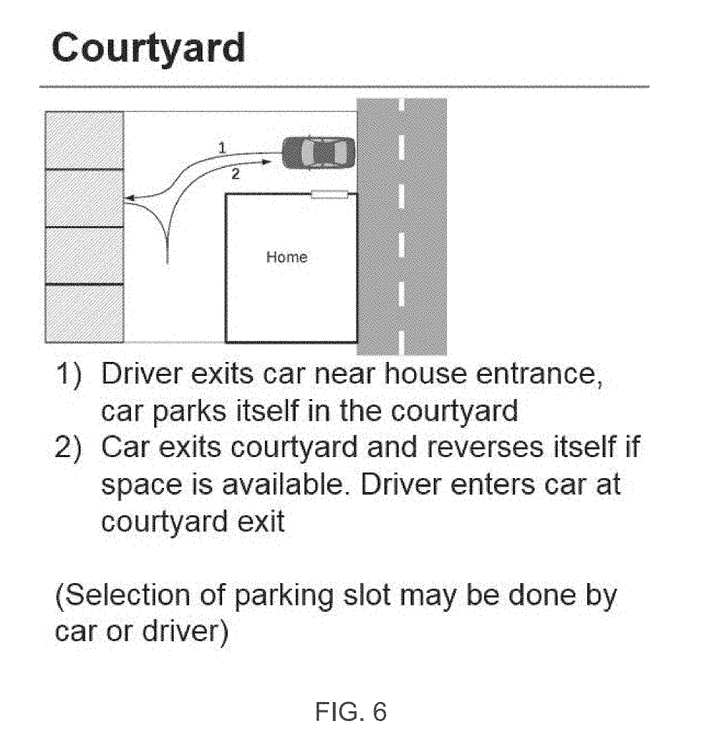

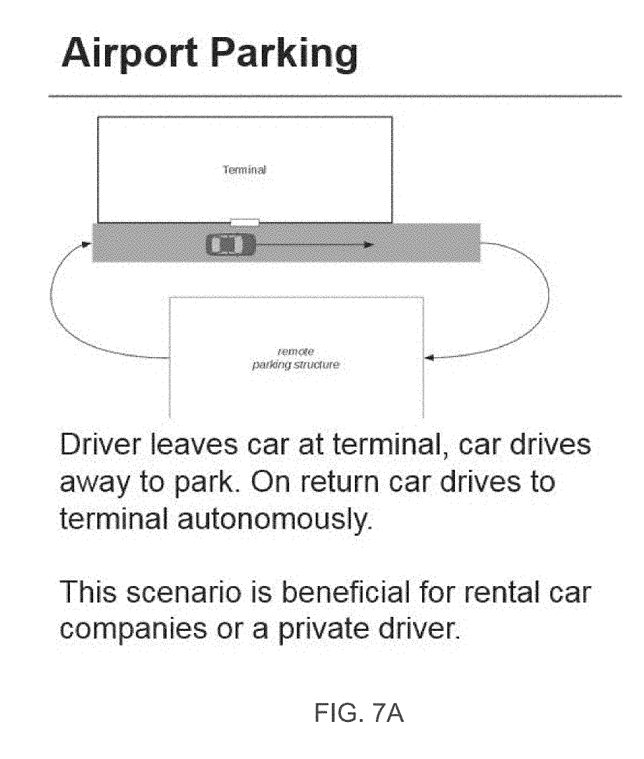

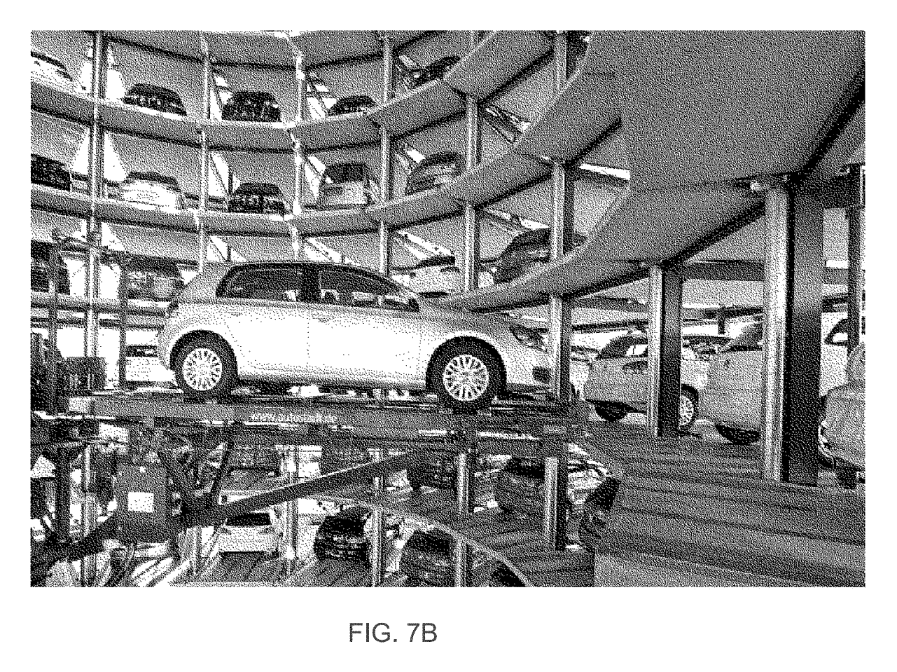

When valet parking was done by another driver such as the personnel of a club or ferry ship or cruise ship or hotel, the vehicle owner leaves his or her vehicle in front of the hotel (or other location) entrance and hands over the key to a valet who then parks the vehicle at a parking lot of the hotel. Nowadays semi-autonomous valet parking for vehicles also intends that a driver can leave the vehicle at the roadside or at a hotel entrance and the vehicle searches a suitable parking spot by itself, such as shown in FIG. 3. Some may be limited to known area nearby parking such as shown in FIG. 4, while some may be capable to overcome an undefined distance within an unknown area, such as shown in FIG. 5. Typically, the spot where the vehicle is left by the driver and the spot that the driver expects the vehicle to come back to is the same. The vehicle may be turned during the parking and the coming back procedure to ease the departure to the driver by receiving the vehicle in exit direction, see FIG. 6. Some advanced ‘valet parking’ implementations intend that the vehicle is able to park itself at a remote parking structure, possibly with several stories. In the example of FIG. 7A, it is assumed that the driver leaves the vehicle at an airport entrance and the valet vehicle parks itself away in a nearby parking structure.

Due to limitations of vehicle inherent sensors, V2V and V2X infrastructure on parking lots and parking structures, guided parking is still in more or less in an experimental stage. It is known to provide such autonomous parking using a garage structure with high end equipment for giving orientation to the vehicle. Due to lacking GPS accuracy in multiple story buildings, the self-localization is key for this task when vehicles park autonomously. Solutions in that area are described in U.S. patent application Ser. No. 15/583,112, filed May 1, 2017 (Attorney Docket MAGO4 P-3018), which is hereby incorporated herein by reference in its entirety. Structures for parking vehicles in a compact way on moving platforms are also known, such as shown in FIG. 7B.

According to an aspect of the present invention, a compact park space saving parking with high comfort to the customer is discussed below, including solutions to several special use cases for autonomous ‘valet’ parking.

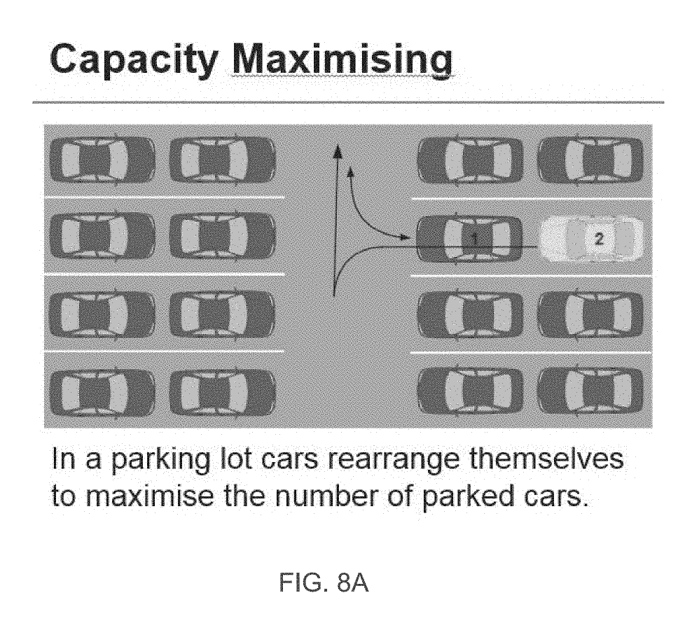

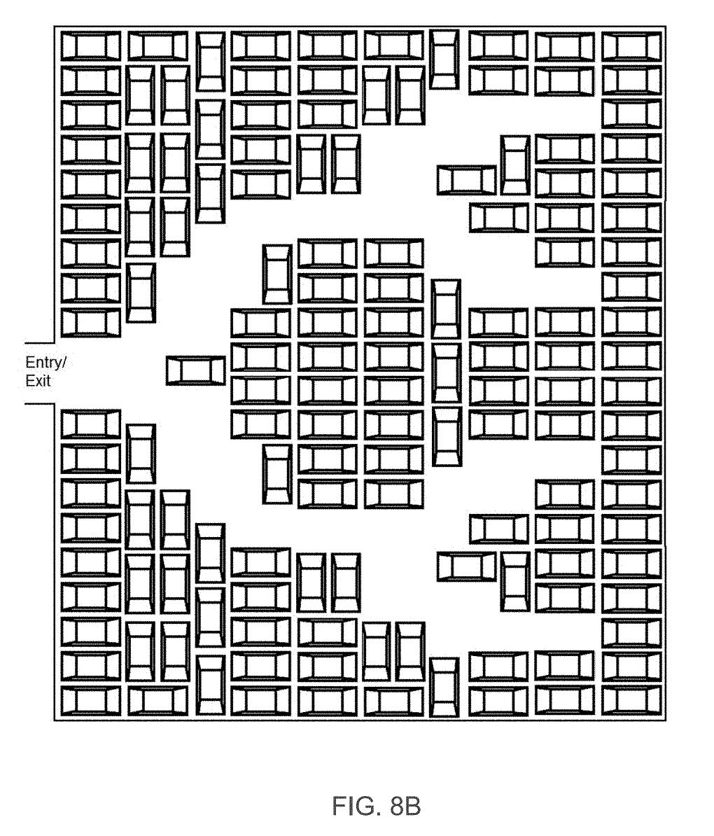

As a solution for maximizing the capacity of a parking lot, it is beneficial to park the vehicles as tight as possible, especially the paths for giving room to enter and leave the parking lots (so the driveways) take a lot of space. By that, an approach to eliminate or to minimize the drive ways will create more space which can be used for more vehicles to be parked, consuming the same space. At valet parking lots or parking structures the drivers may exit their vehicles outside the lot or structure. By that, just unmanned vehicles will move around at the lots or structures. This will eliminate the need to leave space to open the vehicle doors. For compact parking, there may be no exit pathway left open for every vehicle, and some vehicles may be blocked by other vehicles standing in front, behind and side by side of each other, such as shown in FIG. 8A. When a vehicle is called back (via a radio signal, acoustically or via an optical data transmission, optionally under use of optical data transmission means such as specified in the above cited U.S. application Ser. No. 15/583,112) for leaving, but the vehicle exit path is blocked by other vehicles, other vehicles may also be activated and may be commanded to roll out of the way (give clearance) so that enough space opens for the formerly blocked vehicle to exit. The blocked vehicle may then drive autonomously to the exit while the other remaining vehicle(s) may disengage, optionally after restoring an advantage order for the next access.

Optionally, the restoring may not take place or may take place in a limited extent when the parking structure is comparably low occupied, by that there is enough space for every vehicle for maneuvering anyway. Optionally (when the parking structure is medium or highly crowded), the least possible number of other vehicles may be activated upon a wake up event for giving entry or exit clearance. As shown in FIG. 8B, a highly crowded parking garage level can be suitable for unmanned, autonomous (valet) parking vehicles only. The unoccupied spaces in between the parked vehicles serve as maneuvering and driving space for vehicles entering or exiting the parking area. As an optional aspect of the invention, the optimization algorithm for minimizing the number of vehicles that get activated upon a wake up event may arrange the parked vehicles in a way so that the free spaces and/or driving spaces in between have a leaf vein structure. As an alternative option the free spaces and/or driving spaces may appear more or less random or structureless. Optionally, the optimization may work in a manner so that the least possible ways may be driven by the other vehicles upon a wake up event for giving entry or exit clearance. Optionally, the strategy for how to maneuver a plurality of vehicles to give clearance for another vehicle may be done by the parking structure [server]. In accordance with an alternative option, the strategy for how to maneuver a plurality of vehicles to give clearance for another vehicle may be done cumulative by the vehicles by cloud processing. In accordance with an alternative option, the strategy for how to maneuver a plurality of vehicles to give clearance for another vehicle may be set by an instruction set of rules out of which logic the maneuvers are to be executed by the vehicle subject to enter or exit and all other vehicles giving clearance are given. Optionally, when additional vehicles enter the parking lot or structure, the new entering vehicle may enter any available slot which is directly accessible. If this is not possible one or more other vehicles may move into further free spots giving clearance to a spot directly accessible by the newly entering vehicle. Optionally, the optimization may not be limited to one level of the parking structure such as shown in the example of FIG. 8B, but the optimization may reflect all levels of the whole parking structure at once as subject for optimization.

Optionally, when a time scheme is known upon wake up for giving clearance or rearranging for another entering vehicle, the vehicle(s) may rearrange in an optimized way, so that the vehicle which has to leave next (on the time schedule) may be arranged at or near parking areas which are free to the exit path or require low effort in waking up vehicles to move so as to give clearance to the exit path. The time scheme or schedule of each vehicle or several vehicles may come from a bot associated with the vehicle's user's habits (predicting driving activities by watching the driver's habits, such as, for example, the daily driving to and leaving of the work place, picking up children from kindergarten or regular visits to a sports club). The bot may take context information into account. For example, the bot may predict that the driver will rush home at about 7 pm to be back at home at 8 pm when a soccer match of the driver's favorite club is starting. Optionally, the bot may be linked to the user's or users' calendar from which the vehicle usage is predictable due to the necessity of changing the location. For example, if a meeting is scheduled at a certain time in the near future at a place that is too far of a distance for walking, then the determination is made that the vehicle will be used to travel to that place.

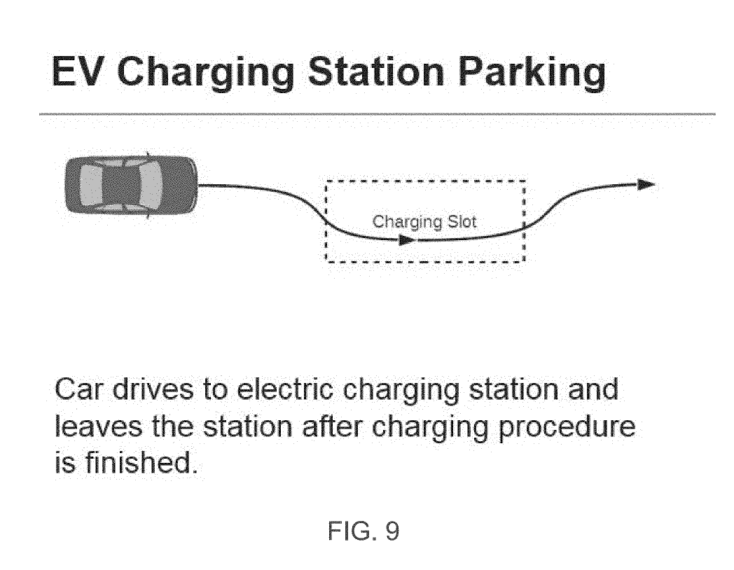

As a solution for, for example, electric vehicle (EV) rental fleets, there optionally may be an alternative or additional feature to the case above. In case the electric vehicle may be made in way to be charged automatically, such as by (plug less) inductive charging or robotic charging plug insertion, there may be dedicated charging spots, slots or stations. To limit the number of necessary charging slots for an EV rental fleet, the system may let the vehicles charge at the charging slot and then these vehicles may clear the charging slot autonomously, as shown in FIG. 9. Optionally, these charged vehicles may enter a valet parking lot or structure and may park in a compact manner as discussed above. Optionally, the discharged vehicle may also be parked in the valet parking lot or structure and may swap their occupied spot with vehicles on the charging slot when these are done with charging from time to time, optionally and optimally without the interference or managing of any human.

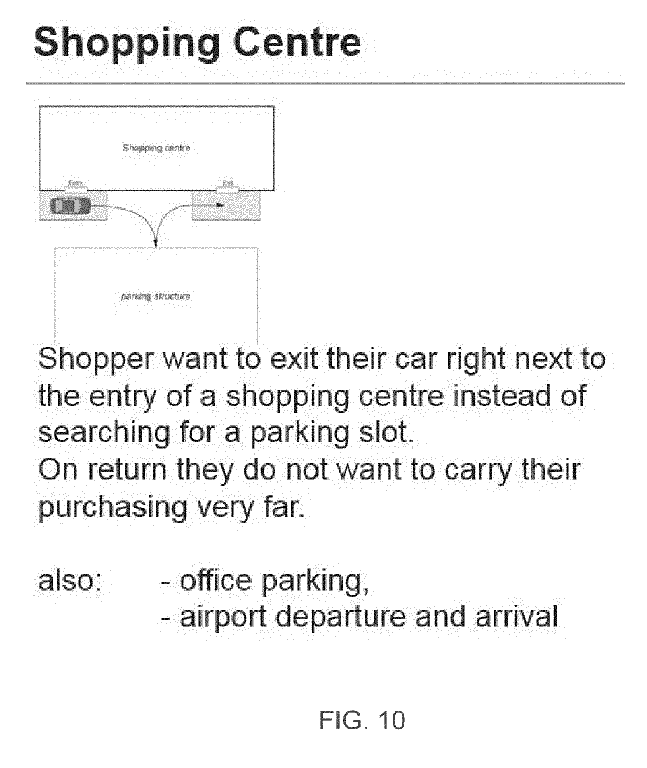

As a solution for, for example, airports or shopping centers, there may be the additional feature that the zone, area or spot at which the driver leaves his or her autonomous or valet parking capable vehicle (formerly referred as autonomous vehicle) may be a different one than the zone, area or spot at which he or she may expect his or her vehicle to be coming to on his or her return. For example, an airport's departure may be at a different story or level than the arrival story or level. Typically, people arrive at the same terminal as they depart when flying back and forth with the same airline, but when returning on a different airline or due to other reasons, a person may arrive at a different terminal than the terminal that he or she departed from. In that case, a traveler may be picked up at the according different terminal or at the arrival story or exit according to a solution of the present invention, see FIG. 10.

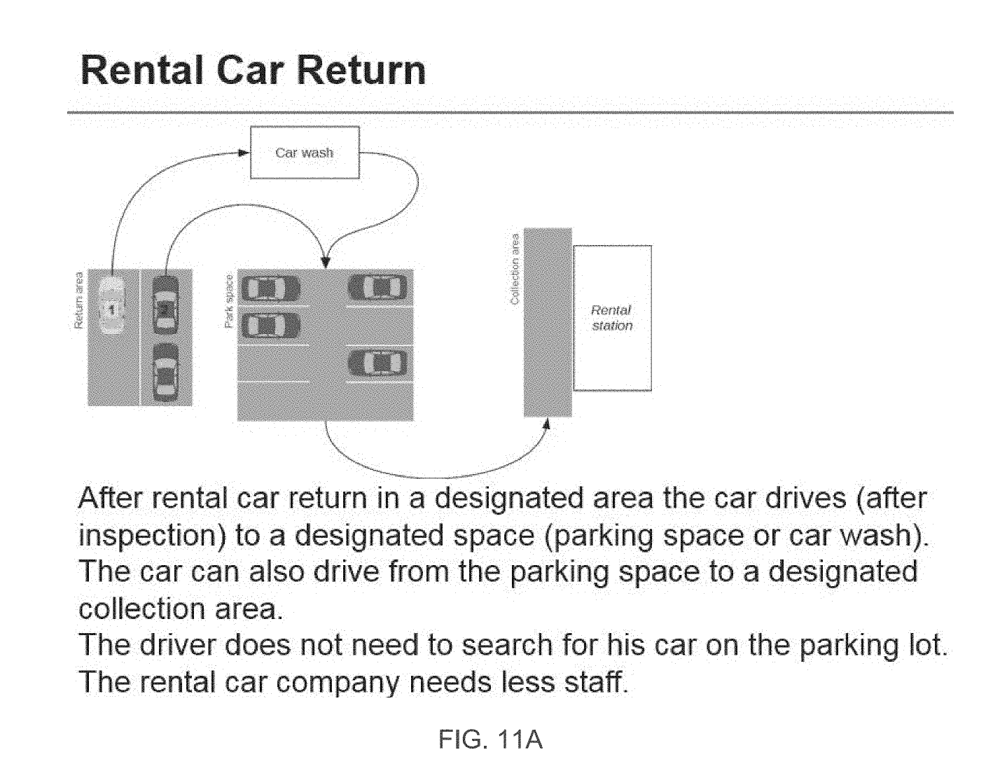

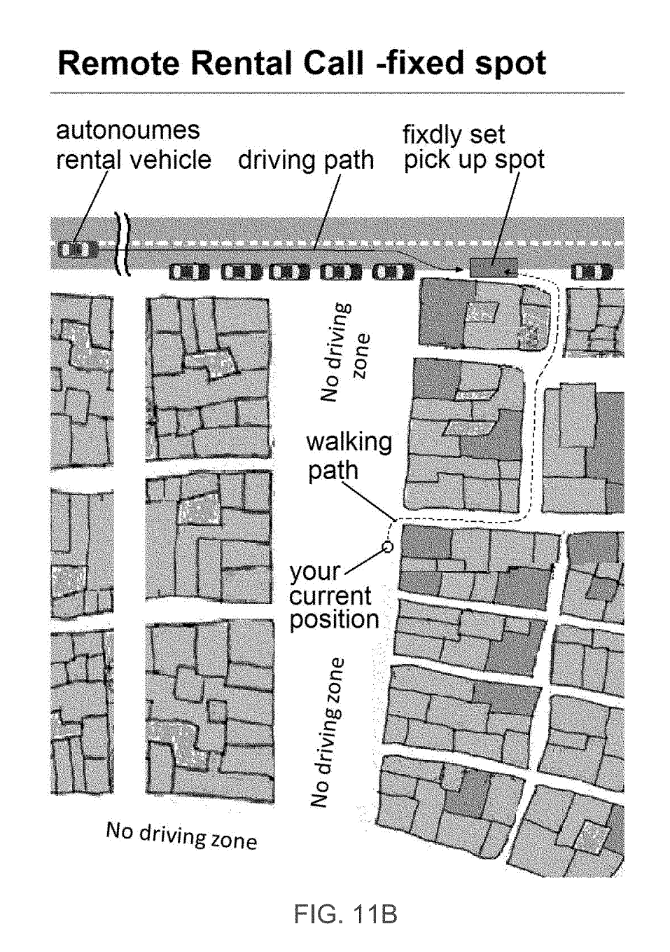

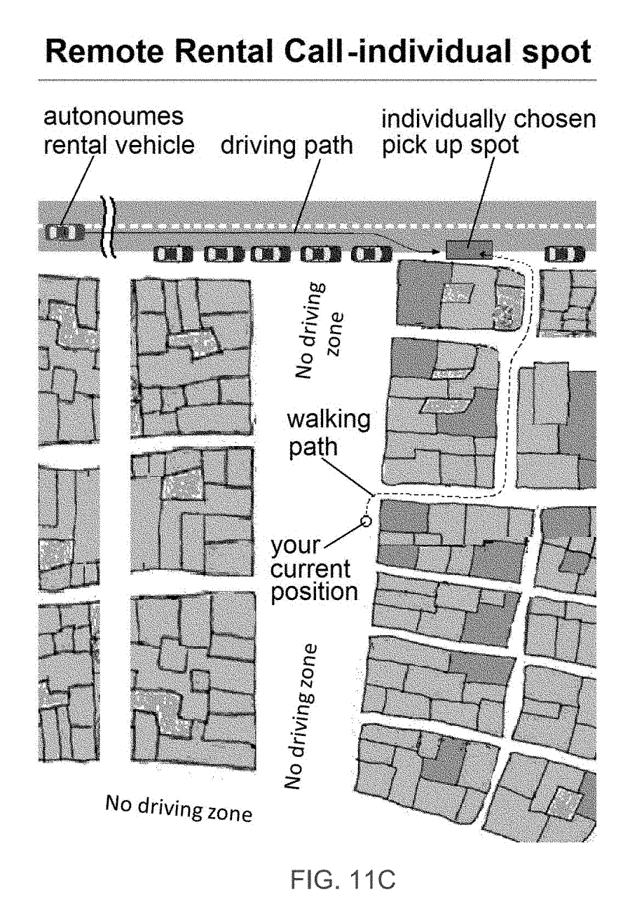

A solution for shared vehicle or vehicle rental companies might be a bit more complex than the solution described above. A customer may enter the rental office and may be served by a service man or a smart phone or computer HMI at which the customer closes the rental deal and receives the key or driving access. As soon it is chosen which (autonomous) vehicle will be designated to the customer, the rental vehicle may exit a closed or remote parking lot and may drive autonomously towards the rental office's exit door or vehicle pick up zone accordingly. When there is more than one customer at a time, the autonomous vehicles may stop in the order that the customers were served previously (keeping the order of service). The customers may enter the autonomous vehicle and may drive away. When the first autonomous vehicle in line leaves the pick-up area, the next autonomous vehicle will pull ahead autonomously to the first pick up place and the following vehicles will close up also. By that, more comfort will be provided to the rental vehicle customers and less rental personnel will be needed for maneuvering vehicles. On vehicle returns, there may be a designated vehicle drop spot, such as, for example, the rental office entrance or a spot in front of an airport departure or bus or train station. As shown in FIG. 11A, after the rental vehicle customer has left the vehicle and picked up his or her luggage, the autonomous vehicle may clear the drop spot autonomously and may optionally drive into a car wash, and optionally before or after that it will drive to a place at which it gets cleaned inside by human or robots, and optionally it will drive to a refuel or recharge station where it gets refueled or recharged automatically or by human, before returning to the rental vehicle parking lot ready for being rented out again. The parking lot may be managed in a space maximized manner as specified above.

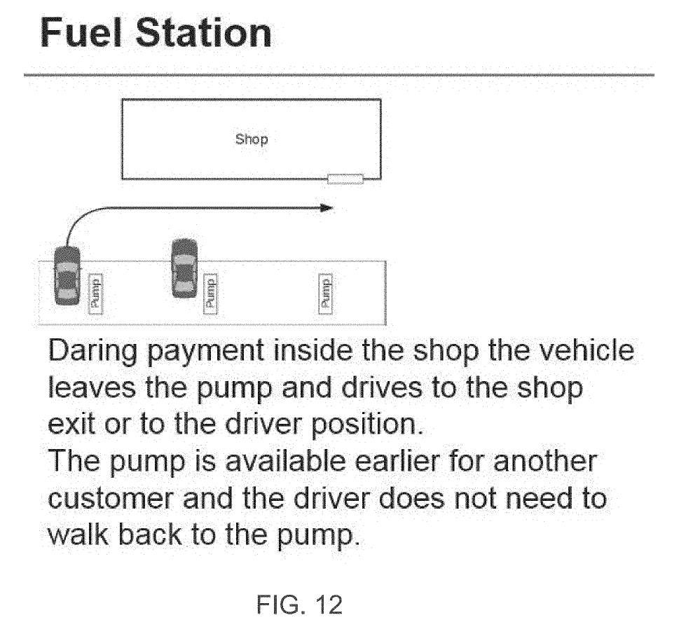

As an inventive solution for refuel or recharge stations, the refueling or recharging (or changing the discharged battery by a charged one) may be executed automatically. During that the driver may leave the vehicle for paying or having a snack. As shown in FIG. 12, the autonomous vehicle may pull to a pick-up area or spot when done with refueling or charging (which is a different spot than the pump or recharge station).

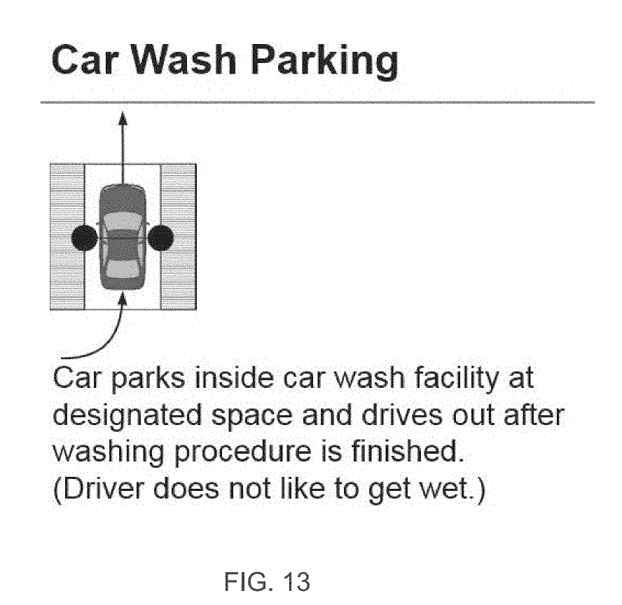

The solution may be similar for car wash facilities. The vehicle may execute the car wash procedure and may return to a pick up spot when done with washing, see FIG. 13.

As another aspect of the invention, when shared or rental cars have autonomous driving capabilities it will be no longer necessary that shared or rental cars get picked up at service stations. As shown in FIG. 11B, the autonomous vehicle may come to the dedicated (fixed) pick up spots unmanned or occupied by an earlier customer for picking up the person who enters or rents the car next, after optionally a renting contract has been agreed remotely by smart phone app or verbally via telephone with the rental company. Optionally, the smart phone app may show the walking path to the rental vehicle pick up spot. Optionally, the spot (and time) where the next driver will be picked up may not be fixed any more but chosen individually for providing a better service to the renting person. Optionally, the individually chosen pickup spot may be selected by the customer or driver himself. Optionally, the individually chosen pickup spot may be chosen or selected by a service person of the car rental. Optionally, the individually chosen pickup spot may be chosen or determined by an artificial intelligence algorithm or app, provided by the car rental or car sharing company or by third party. Optionally, the pickup spot may be chosen in an optimized way by an optimization algorithm (within the app). Optionally, multiple but at least one of the following optimization criteria may be reflected by the optimization algorithm, such as minimal walking distance for the next customer (or driver), minimal waiting time for the customer until the shared or rental car arrives, fastest possible driving path for the shared or rental car to reach the chosen pick up spot, minimal driving distance for the shared or rental car until reaching the chosen pick up spot, the area of best probability to find a spot for stopping for picking up the customer, a spot which complies best to traffic rules, a spot safe for stopping a picking up the customer in terms of traffic safety, a spot safe for stopping a picking up the customer in terms of personal safety, and/or a spot for picking up the customer to which the walking path is the safest in terms of personal and traffic safety (for example when picking up children) originating from the current position of the customer. Optionally, the optimization algorithm may take into account the weather conditions (acquired from the internet or by vehicle sensors), the traffic conditions (acquired from the internet, by crowd wisdom, or by experience), the time of day, the season and one-time events (for example a carnival parade or a bike race) when selecting or choosing or determining an optimized pick up spot.

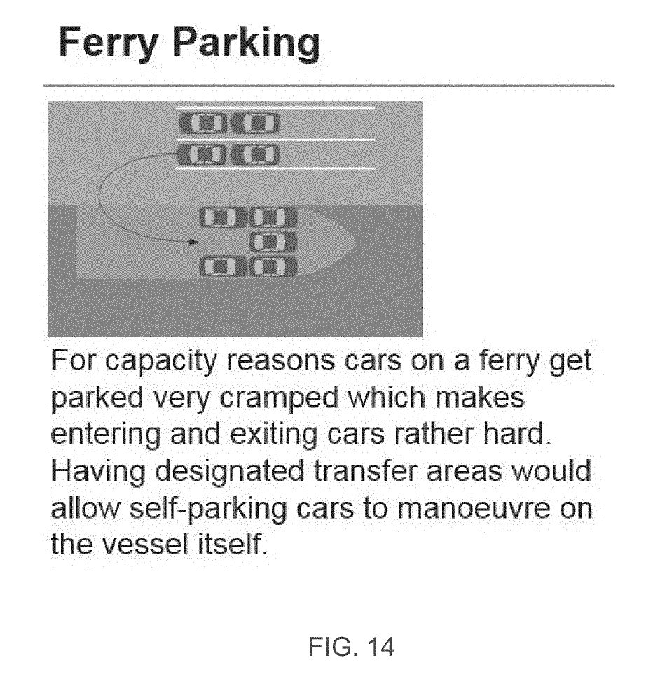

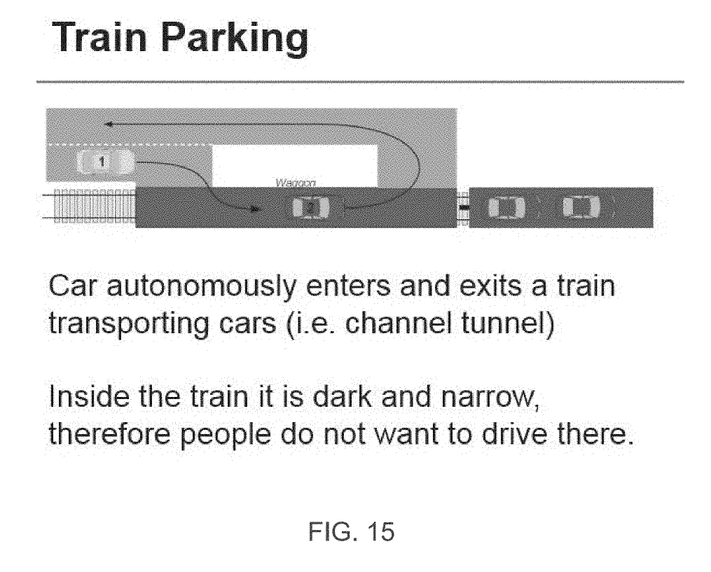

Different to the compact parking on parking lots or parking facilities of autonomous vehicles specified above, for a parking task on roll on—roll off ferries and trains, it may be foreseeable which vehicle has to leave at which remote port or train station, due to the ticket which was booked for designated vehicle or which delivery task was specified, see FIGS. 14 and 15. The transport logistics may be optimizable or done automatically instead by human by loading (rolling on) the vehicles first which have to leave at last or to load vehicles at a (designated) position which allows them to leave with the least effort to maneuver vehicles around which have to stay. A foreign or remote planning server may calculate the optimized vehicle positions. Each autonomous vehicle may receive its designated parking spot via wireless data communication and may receive an order when to start rolling on and after which other vehicle, so as to achieve the planned order. Optionally, this may happen in a mix with human driven non autonomous vehicles. Optionally, there may be a designated shipping mode for the autonomous vehicles, which may engage after the autonomous vehicle has reached its designated spot on the ship or train or when an according command was received, such as, for example, a command from a remote ferry parking optimization server. During shipping mode, the vehicle alarm may be modified to not react upon shock, vibration, position and orientation change, and other energy saving measures may be activated. The vehicles may exit the ferry or train autonomously at their destination port or train station.

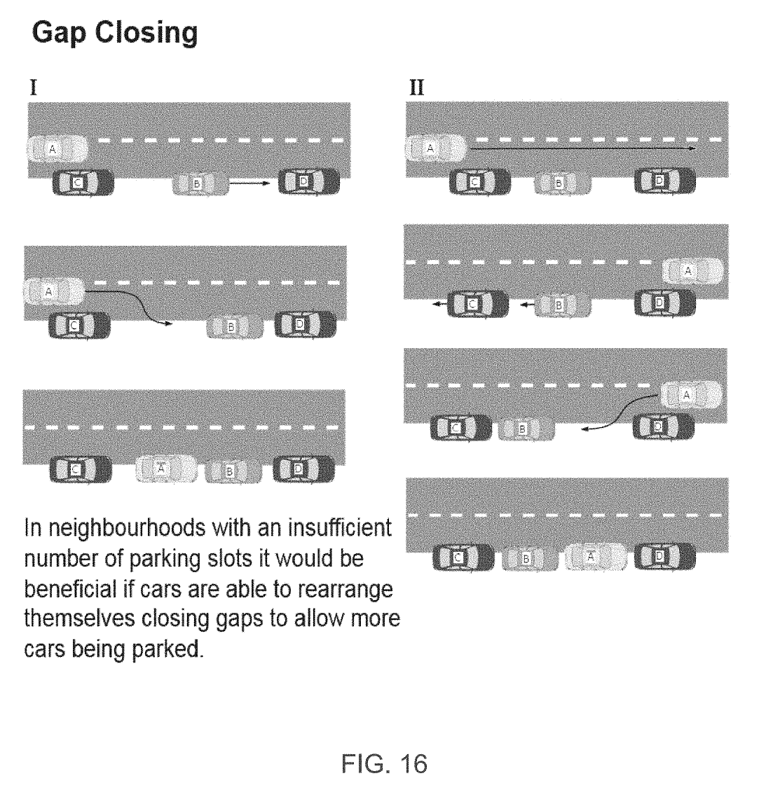

As a solution for automated vehicle parking on road sides at neighborhoods with an insufficient number of parking spots (lot or slots), autonomous vehicles may rearrange themselves for closing gaps in between to allow as many vehicles as possible to park at a given area. The gap closing may be triggered when another vehicle approaches which is searching for a parking spot and no parking spots are left nearby. The approaching vehicle may transmit its parking spot search request and own dimension via V2V. The scenario I of FIG. 16 shows this in example. In scenario I, the already parked vehicles C and D keep their position since it is sufficient that only the already parked vehicle B wakes up and moves forward a few centimeters (or more) to open a gap that is large enough for the approaching subject vehicle A to park in forwardly. Optionally, alternatively the already parking vehicles may acknowledge the newly approaching vehicle is searching for a parking spot by its behavior (such as, for example, slow driving, running ultrasound sensors, stopping on a gap nearly big enough for it to park in). By that option, approaching vehicles without V2V capabilities, also when human driven, may be reflected as well by the already parked autonomous vehicles. The scenario II of FIG. 16 shows this in example. In scenario II, the already parked vehicle D keeps its position while the already parked vehicles B and C wake up and move rearward a few centimeters (or more) to open a gap in front of vehicle B that is large enough for the approaching subject vehicle A to park in, such as by a two stroke rearward parking maneuver. Optionally, for opening a gap, the parking vehicles may transmit their identity, position and remaining gaps in between one another. In case the sum of the remaining gaps plus some maneuvering and safety distance (>distance sensor accuracy) between the vehicles is greater than the space required for the newly approaching vehicle, one or more of the already parked autonomous vehicles may rearrange either pulling forward or backward for some centimeters under regard of parking regulations, pedestrians and obstacles, without leaving the area allowed to park (also shown in the example of scenario II of FIG. 16). The rearranging calculation or optimization may run on a single vehicle, on a group processing of a plurality of concerned (parked and the approaching) vehicles, on a remote server, one or more local or remote smart phones or cloud processing or server. It may happen that not all vehicles parked along a roadside are automated or V2V capable and by that are not able to rearrange on request. Optionally, parked vehicles around these may reflect these as fixed points in their gap minimizing calculation, rearranging in the remaining spaces.

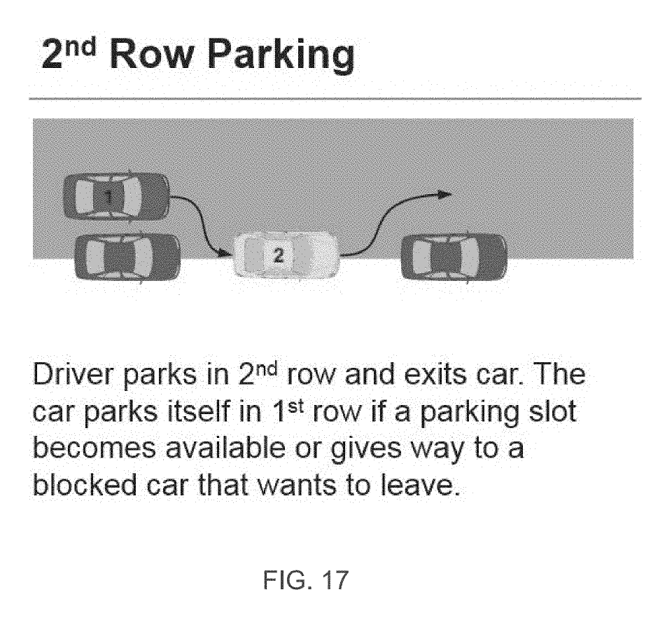

The solution above may give the driver the opportunity to leave the vehicle anywhere in a second row of road side parked vehicles and leave it to his or her automated vehicle to park itself. The vehicle may park itself into the first row when a free space has opened since a (any) vehicle has left or a spot was opened by rearranging autonomous vehicles in the manner specified above, see example of FIG. 17. Optionally, as another solution, the vehicle may idle around a block or drive up and down a road autonomously until a regular (allowed or intermediate (specified below)) parking spot is found and the vehicle is parked or the driver returns and gets picked up.

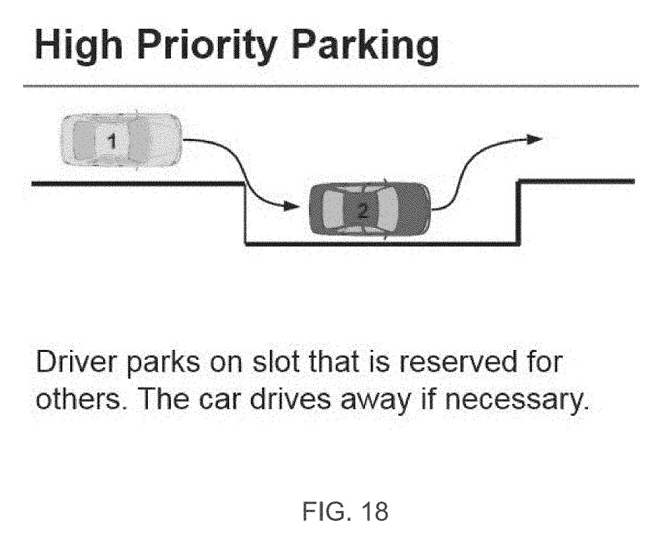

As an option for autonomous vehicles, it may be possible to allow them to park at privileged or reserved parking spots or lots as long these are not required by the privileged vehicles. The privileged vehicles may always keep priority. As soon as a privileged vehicle approaches a privileged parking spot blocked by a non-privileged vehicle, the non-privileged vehicle may autonomously clear the parking spot which may than be entered by the privileged vehicle while the non-privileged vehicle may have to find a different spot or idle around the block or the driver may have returned, see FIG. 18.

The owner of the privileged, reserved or private parking spots may demand a parking fee (or fine) for any vehicle parking there. A parking fee or fine is typical also to pay at public parking lots or parking structures. The billing is typically handled by the vehicle driver, either at an entrance or exit gate or at a cashier machine near by the parking lot or structure or by smart phone app.

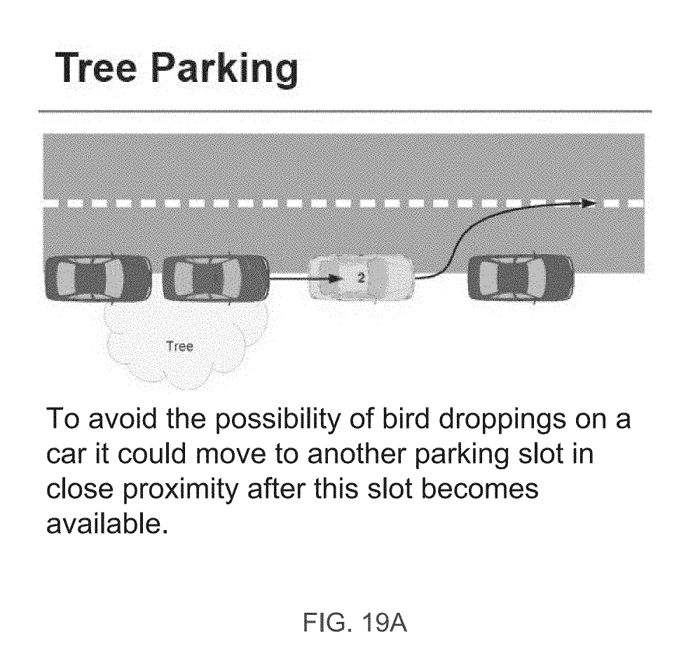

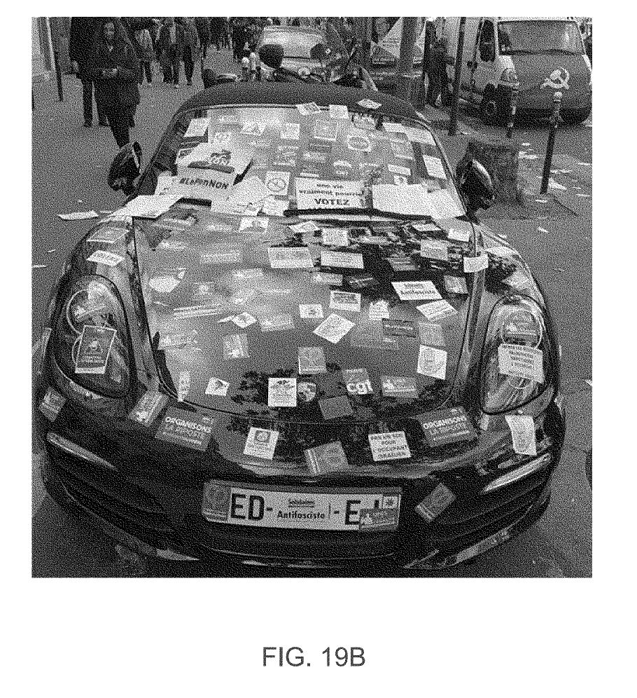

Rearranging of vehicles may also be a solution for different reasons. For example, there may be parking spots which are to be preferred to be parked at compared to other spaces (when free), may this be that the vehicle may preferably park in the shade (for keeping the compartment comfortable) of, for example, a tree or a building, may this be that the vehicle may preferably park under a roof, such as, for example, when it snows (for keeping it off snow), may this be that the vehicle may preferably not park under trees which potentially leave bird droppings (see FIG. 19), may this be that the vehicle may preferably park in an area with well illumination for allowing the driver a safer return to his or her vehicle, may this be that the vehicle may preferably park farthest from a protest march path which is about to pass for preventing the vehicle from damage or vandalism such as shown in the example of FIG. 19B. The different reasons may depend on the vehicle type, season and/or daytime or may depend on single events (for example, a soccer match in the local town) which may be a result of a context analysis of news, crowd wisdom or attitude, weather forecast and/or traffic reports optionally analyzed by an artificial intelligence. Optionally, the autonomous vehicle may enter the preferable spot right from the beginning or when the preferred spot becomes free. Optionally, the autonomous vehicle may park and reengage autonomously from time to time to change positions, such as, for example, when following the shadow and shade of a tree which is changing with the sun.

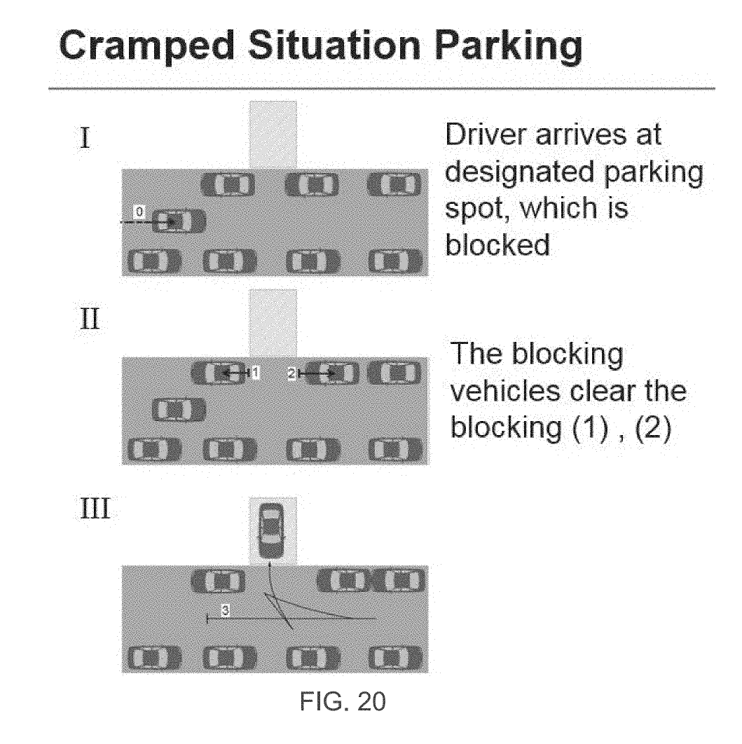

As a solution for automated vehicle parking on road sides with private property parking lots or driveways attaching on the road sides it may occur from time to time that the private entrances are blocked by the road side parked vehicles. This may occur especially when the private entrances were not acknowledged as such properly when these were picked as parking spots by automatically parking or autonomous vehicles earlier. FIG. 20I shows such a situation in example. By the present solution, the autonomous vehicles parked at the road side may autonomously open a gap by maneuvering sufficiently backwardly or forwardly for an approaching vehicle to enter a private property lot, see FIG. 20II. In the example of FIG. 20III, the approaching vehicle may have a preferred parking orientation which requires additional space for turning around, this may be reflected by the autonomous vehicles when opening the gap. When established, the legislation may allow autonomous vehicles to park in front of private entrances on purpose, when it is ensured that these vehicles are able to give clearance on request.

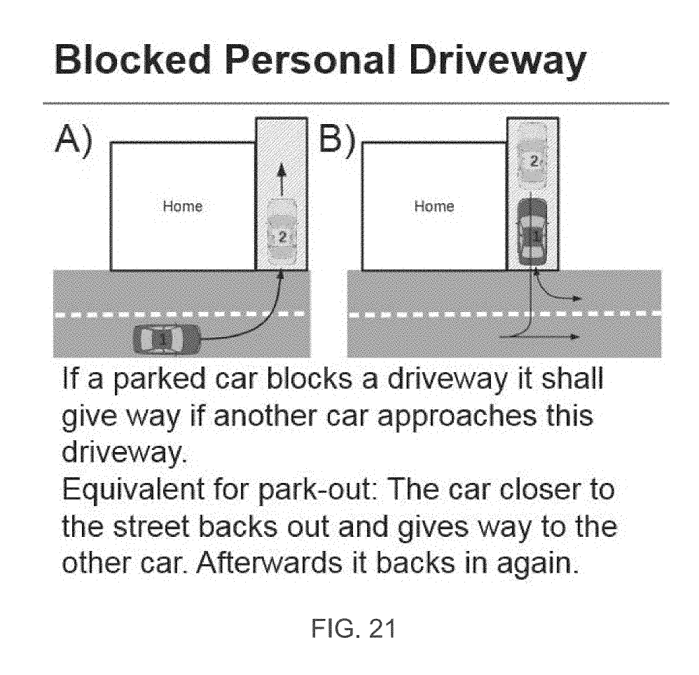

For automated vehicles parking in driveways behind one another with too less space to pass there may be a solution to give clearance to the vehicle which is approaching or needs to leave. In the example of FIG. 21A, at least the vehicle 2 may have autonomous driving abilities. It may give clearance by driving deeper into the driveway when another vehicle is entering. When it comes to leaving its trivial when the vehicle which has to leave stands next to the exit. When the vehicle which has to leave is the vehicle not next to the exit, the autonomous vehicle next to the exit may give clearance by exiting the driveway to let the other vehicle (vehicle 2 in FIG. 21B) through, it may do it in a way that the other vehicle can leave easily and in a way that the road traffic is harmed the least, optionally vehicle parking trajectory planning methods and algorithm may be used to plan and execute the necessary maneuvers, such as by utilizing aspects of the systems described in U.S. Publication No. US-2017-0015312, which is hereby incorporated herein by reference in its entirety.

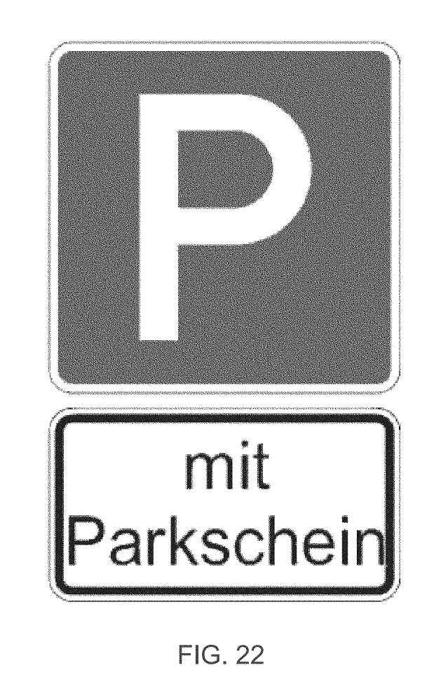

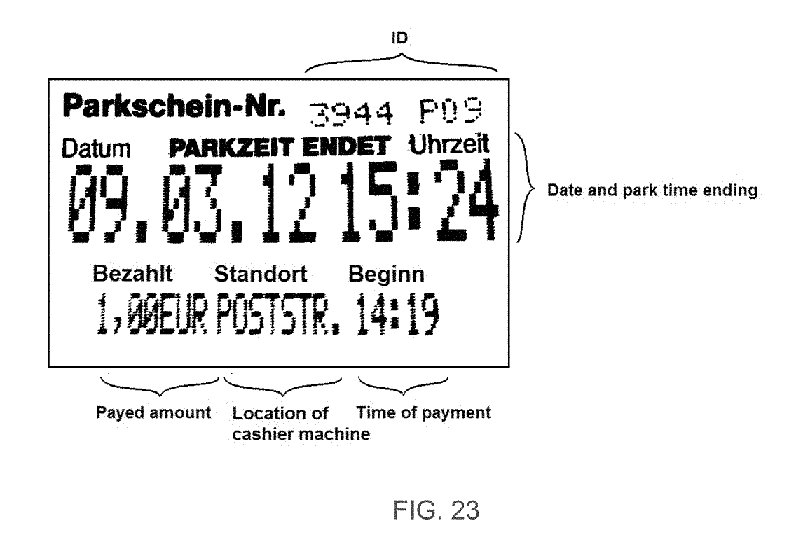

For autonomous vehicle parking at public parking spaces, where a parking fee or fine is typically required to pay at public parking lots or parking structures, payment may not be made when the driver is not present, since payment is typically handled by the vehicle driver, either at an entrance or exit gate or at a cashier machine near by the parking lot or structure or by smart phone app. For autonomous or valet parking vehicles entering a valet parking lot or structure with occupants or driver less, the payment may be done automatically, such as, for example, by charging the vehicle owner's credit card. This solution is insufficient for parking areas (such as these marked in a way as shown in FIG. 22) at which it is required to pay upfront at a cashier machine and to leave the printed parking ticket (an exemplary parking ticket is shown in FIG. 23) behind the vehicle's windshield so as to be readable from outside the vehicle by meter maids, since the owner of an autonomously driven vehicle is absent from the vehicle and not handling the paying and placing the park ticket behind the windshield when his or her car is entering the parking spot without him or her.

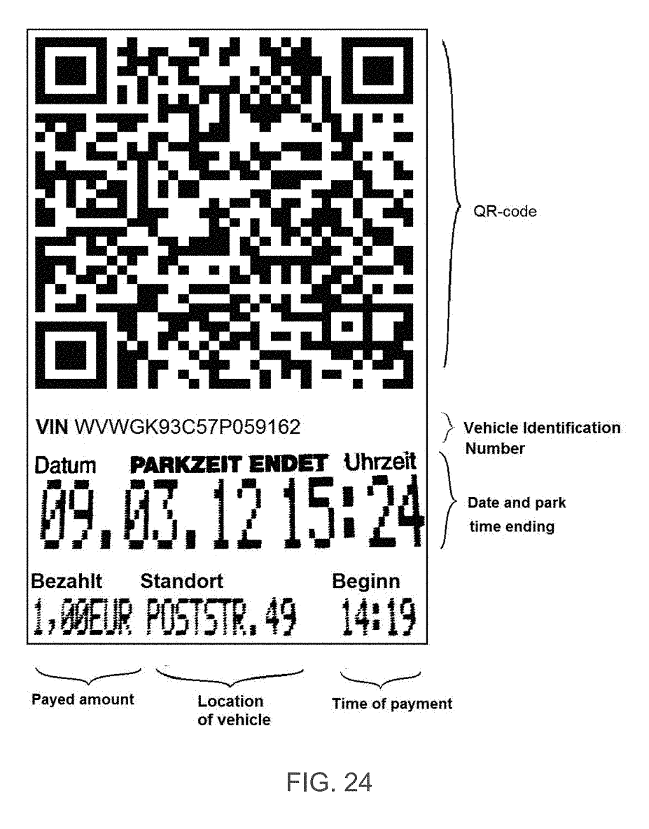

As an inventive option for autonomous vehicles, the vehicle may have a display area, readable from outside the vehicle, optionally at a region and readability required by law, such as, for example, at the lower left corner of the windshield facing outward, that displays parking information, such as whether a parking fee has been paid for the subject automated vehicle's parking and optionally displaying the time at which the paid parking period expires. The display may have a display content as shown in FIG. 24. Optionally, instead of the parking ticket cashier machine ID and location (on the parking ticket), the parking display may display the vehicle's location and its vehicle identification number (VIN) or Fahrzeuggestellnummer or the license plate number to identify the vehicle. The display may display the fact that a payment for the parking has taken place and the time to when the payment is sufficient. Optionally, the vehicle may transmit the parking payment data by any suitable type of V2X (vehicle to infrastructure) device and data channel, especially for allowing an automated read out by meter maids. Of course with having such a V2X connection, meters maids may become obsolete. Optionally, the city may have drones able to exercise the parking control instead of meter maids. Optionally, the parking traffic regulations may be adapted according the parking ticketing solution of the present invention.

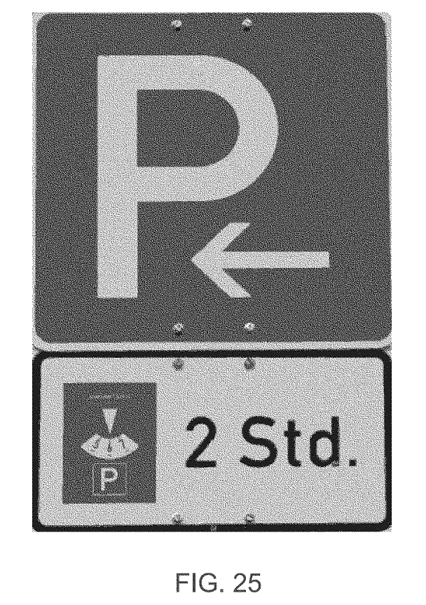

Some parking areas require to put up a ‘Parkscheibe (parking disc)’, displaying the arriving time rounded up to the next half hour. Typically, a traffic sign such as shown in example of FIG. 25 regulates the maximal parking time allowed to park on an according parking spot. Since an autonomous vehicle, which may enter such a parking place without a driver automatically, is not able to put up a Parkscheibe (parking disc) by itself, as an inventive option, similar to the above, the vehicle may have a display area, readable from outside, optionally in a region and readability required by law, such as, for example, at the lower left corner of the windshield facing outward, that displays the arrival time or rounded up arrival time or that displays an image of a Parkscheibe (parking disc), favorably in the color, size and ratio required by law for Parkscheiben (parking discs), with the arrival time rounded up to the next half hour as required by law. The current law in Germany forbids that the Parkscheibe (parking disc) gets adapted to later arrival times with consecutive lapse of time by itself (automatically) while its vehicle is being parked at a spot with up to the next half hour as required by law. The current law in Germany forbids that the Parkscheibe (parking disc) required. The system of the present invention may optionally be capable to do such an adaption but this option may be turned off by default.

Thus, the present invention may autonomously park a vehicle, such as responsive to a user input when the vehicle is initially stopped or parked by the driver (such as at an entrance to a building where there is no parking space), by moving the vehicle from the drop-off location to a parking location remote from the drop-off location. The system parks the vehicle at a parking space and may later move the vehicle to adjust the parking location (such as to move to a preferred parking space or to make room for another vehicle) or to rearrange parked vehicles (such as to arrange the vehicles in an order that eases retraction or departure of the vehicles from the parking spaces). The system may communicate with other vehicles to determine a parking space or to create a parking space and may communicate with other vehicles to arrange vehicles to be parked at a parking area.

When the driver wants the vehicle back, another user input may be actuated, whereby, responsive to the other user input, the control drives the vehicle to the pick-up location (which may be determined by where the drop-off location was or may be entered by or provided by the second user input, or the control may drive the vehicle to the current geographical location of the driver when actuating the second user input). The user inputs may comprise any suitable inputs, such as a signal from a smart phone or the like, whereby the system may determine the driver's location via the GPS of the phone and the signal from the phone.

The system may utilize any suitable sensors to assist in determining its location and to detect objects or other vehicles during the autonomous driving. For example, the vehicle may have a plurality of cameras and/or RADAR sensors and/or LIDAR sensors and/or ultrasonic sensors and/or the like. The system may utilize sensors, such as radar or lidar sensors or the like. The sensing system may utilize aspects of the systems described in U.S. Pat. Nos. 9,146,898; 9,036,026; 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication No. WO 2011/090484 and/or U.S. Publication No. US-2010-0245066 and/or U.S. patent application Ser. No. 15/467,247, filed Mar. 23, 2017 (Attorney Docket MAGO4 P-2978), Ser. No. 15/446,220, filed Mar. 1, 2017 (Attorney Docket MAGO4 P-2955), and/or Ser. No. 15/420,238, filed Jan. 31, 2017 (Attorney Docket MAGO4 P-2935), and/or U.S. provisional applications, Ser. No. 62/375,161, filed Aug. 15, 2016, Ser. No. 62/361,586, filed Jul. 13, 2016, Ser. No. 62/359,913, filed Jul. 8, 2016, and/or Ser. No. 62/349,874, filed Jun. 14, 2016, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or 4G or 5G) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or U.S. Publication Nos. US-2012-0162427; US-2006-0050018 and/or US-2006-0061008, which are all hereby incorporated herein by reference in their entireties. Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. An autonomous parking system for a vehicle, said autonomous parking system comprising:
a plurality of sensors disposed at a vehicle equipped with said autonomous parking system and having respective fields of sensing exterior of the equipped vehicle;
a processor operable to process data captured by said sensors;
a control operable to control steering, moving and stopping of the equipped vehicle responsive at least in part to processing by said processor of captured data;
wherein, responsive at least in part to a user input, said control autonomously drives the equipped vehicle from a drop-off location to a parking space and parks the equipped vehicle at the parking space;
wherein, responsive at least in part to another user input, said control autonomously drives the equipped vehicle from the parking space to a pick-up location; and
wherein one of (i) the pick-up location is different than the drop-off location, (ii) said control is operable to move the equipped vehicle after it is parked without actuation of the other user input, and (iii) said control communicates with controls of other vehicles in determining the parking space for the equipped vehicle.

2. The autonomous parking system of claim 1, wherein the pick-up location is different than the drop-off location.

3. The autonomous parking system of claim 1, wherein said control is operable to move the equipped vehicle after it is parked and without actuation of the other user input.

4. The autonomous parking system of claim 3, wherein said control moves the equipped vehicle to make space for another vehicle at or near the parked equipped vehicle.

5. The autonomous parking system of claim 3, wherein said control moves the equipped vehicle to rearrange a plurality of parked vehicles.

6. The autonomous parking system of claim 3, wherein said control moves the equipped vehicle to another parking space responsive to a preferred parking location becoming available after the equipped vehicle is parked.

7. The autonomous parking system of claim 1, wherein said control communicates with controls of other vehicles in determining the parking space for the equipped vehicle.

8. The autonomous parking system of claim 7, wherein said control moves the equipped vehicle to rearrange an order of a plurality of vehicles to be parked.

9. The autonomous parking system of claim 7, wherein said control, responsive to communication with controls of other vehicles, moves the equipped vehicle to rearrange a plurality of parked vehicles.

10. The autonomous parking system of claim 1, wherein said sensors at least comprise a plurality of cameras disposed at the equipped vehicle and having respective exterior fields of view.

11. An autonomous parking system for a vehicle, said autonomous parking system comprising:
a plurality of sensors disposed at a vehicle equipped with said autonomous parking system and having respective fields of sensing exterior of the equipped vehicle;
a processor operable to process data captured by said sensors;
a control operable to control steering, moving and stopping of the equipped vehicle responsive at least in part to processing by said processor of captured data;
wherein, responsive at least in part to a user input, said control autonomously drives the equipped vehicle from a drop-off location to a parking space and parks the equipped vehicle at the parking space;
wherein, responsive at least in part to another user input, said control autonomously drives the equipped vehicle from the parking space to a pick-up location; and
wherein (i) said control communicates with controls of other vehicles in determining the parking space for the equipped vehicle and (ii) said control is operable to move the equipped vehicle after it is parked without actuation of the other user input.

12. The autonomous parking system of claim 11, wherein said control moves the equipped vehicle to make space for another vehicle at or near the parked equipped vehicle.

13. The autonomous parking system of claim 11, wherein said control moves the equipped vehicle to rearrange a plurality of parked vehicles.

14. The autonomous parking system of claim 11, wherein said control moves the equipped vehicle to another parking space responsive to a preferred parking location becoming available after the equipped vehicle is parked.

15. The autonomous parking system of claim 11, wherein said control moves the equipped vehicle to rearrange an order of a plurality of vehicles to be parked.

16. The autonomous parking system of claim 11, wherein said control, responsive to communication with controls of other vehicles, moves the equipped vehicle to rearrange a plurality of parked vehicles.

17. An autonomous parking system for a vehicle, said autonomous parking system comprising:
a plurality of sensors disposed at a vehicle equipped with said autonomous parking system and having respective fields of sensing exterior of the equipped vehicle;
a processor operable to process data captured by said sensors;
a control operable to control steering, moving and stopping of the equipped vehicle responsive at least in part to processing by said processor of captured data;
wherein, responsive at least in part to a user input, said control autonomously drives the equipped vehicle from a drop-off location to a parking space and parks the equipped vehicle at the parking space;
wherein, responsive at least in part to another user input, said control autonomously drives the equipped vehicle from the parking space to a pick-up location;
wherein (i) the pick-up location is different than the drop-off location, (ii) said control communicates with controls of other vehicles in determining the parking space for the equipped vehicle, and (iii) said control is operable to move the equipped vehicle after it is parked without actuation of the other user input; and
wherein said control moves the equipped vehicle after it is parked to rearrange a plurality of parked vehicles.

18. The autonomous parking system of claim 17, wherein said control communicates with controls of other vehicles in moving the equipped vehicle after it is parked.

19. The autonomous parking system of claim 18, wherein said control, responsive to communication with controls of other vehicles, moves the equipped vehicle in cooperation with movement of the other vehicles to rearrange the plurality of parked vehicles.

20. The autonomous parking system of claim 17, wherein said sensors at least comprise a plurality of cameras disposed at the equipped vehicle and having respective exterior fields of view.
